(19) United States
(12) Patent Application Publication
(10) Pub. No.: US 2005/0229097 A1
(43) Pub. Date: Oct. 13, 2005

(54) Systems and methods for layered XML schemas

(75) Inventor: Richard Eric Lander, Redmond, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/822,185

(22) Filed: Apr. 9, 2004

(51) Int. Cl. G06F 17/30; G06F 17/24

(52) U.S. Cl. 715/517; 715/513

(57) ABSTRACT

The layered schema design facilitates subsequent schema creation and can aid in homogenizing the properties of schemas that rely on it. The layered schema design provides a plurality of schemas that work together, but can be broken apart to allow for flexible access to desired properties without excess schema overhead. To accomplish this, schemas at the bottom layer providing the most basic and widespread schema properties, progressing to schemas at the top layer providing the most specialized and complex properties. Each intermediate later provides a set of properties that can rely on the properties in the layers below it, but not on the layers above it. Each layer may also include a plurality of schemas with subsets of schema properties. This allows developers of new schemas to incorporate only so much of the layered schema design as necessary.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2003, Microsoft Corp.

### FIELD OF THE INVENTION

This invention relates to computing, and more particularly to the Extensible Mark-up Language (XML) and XML Schema Language (XSL).

### BACKGROUND OF THE INVENTION

The Extensible Markup Language (“XML”) is an important modem development in document syntax format. XML has been adopted in fields as diverse as law, aeronautics, finance, insurance, art, and software design. It has become syntax of choice for newly designed document formats across almost all computer applications. XML is used to store and exchange information on cell phones, personal computers (PCs) and large business mainframe computers. The World Wide Web Consortium (W3C) has endorsed XML as the standard for document and data representation. XML has been called the most reliable and flexible document syntax ever invented.

XML is a meta-markup language for text documents. Data is included in XML documents as strings of text, and the data is surrounded by text markup that describes the data. A particular unit of data and markup is called an element. The XML specification defines the exact syntax this markup must follow: how elements are delimited by tags, what a tag looks like, what names are acceptable for elements, where attributes are placed, and so forth.

Calling XML a meta-markup language suggests one important feature of XML. XML, unlike other markup languages (e.g., Hyper Text Markup Language, or HTML) does not have a fixed set of tags and elements that are always supposed to work for everyone in all areas of interest. Instead, XML allows developers and writers to define the elements they need as they need them. An architect can create an XML element called “skyscraper,” a chemist can create “Bunsen burner” element, and a shipping company can create a “tractor trailer” element. This feature of XML is also referenced in its name: the Extensible Markup Language.

While the extensible nature of XML makes it versatile enough to adapt to many fields—and rapidly changing fields—it also presents a problem of interoperability. Programs can be written to read and operate on particular XML data, and such programs may not recognize XML data that does not fit the proper description. For example, programs written to recognize the chemist's Bunsen burners, above, may not also recognize the shipping company's tractor trailers. While the chemist and the shipping company may not consider this a problem, a large company with many departments using different XML elements may find it troublesome.

This dilemma has been met with several solutions. One solution is the Document Type Definition (“DTD”). A DTD specifies tags, or “markup” and how the tags can relate to one another. The markup in a DTD describes structure for an XML document. It lets you see which elements are associated with which other elements. A DTD lists all legal markup and specifies where and how the markup may be included in a document. Particular XML document instances can be compared to the DTD. Documents that match the DTD are said to be valid. Documents that do not match are said to be invalid. Therefore, validity of an XML document depends on which DTD it is compared to.

Yet another solution is XML schemas, which are written using XML schemas. XML schemas are a somewhat more rigorous framework for declaring the structure and contents of XML documents. In addition to the basic element and attribute relationships that can be defined in a DTD, schemas allow for specific data type restrictions on their documents' contents. Schemas also provide support for the construction of user-defined complex data types, data ranges, and masks.

FIG. 1 provides two pseudo schemas, which are abstractly presented to facilitate illustration of schema concepts. As shown in FIG. 1, an XML Schema Document (“XSD”) may include a number of declared data properties. FIG. 1 declares a type 1, type 2, type 3, and type N, as well as a number of elements and an attribute, intended to show that the properties declared in a schema can be infinitely variable and can depend on properties declared elsewhere. This is well understood in the art.

XML documents that conform to an XML schema, such as pseudo schema 1, must have the properties declared in the schema when they use tags indicating data of a particular data type. For example, if an XML document conforming to pseudo schema 1 had a tag indicating data of type 1, it would have to also have tags indicating properties conforming to element 6, element 2, and element 4.

As shown in FIG. 1, each data type may include properties of both simple and complex types. For example, type 1 from FIG. 1 contains one property of a complex data type (element 6) and two properties with simple data types (elements 2 and 4). A simple data type does not have child elements or attributes. A list of some 34 simple data types is provided by the official World Wide Web Consortium website, www.w3.org. Examples of these are “string,” indicating a string of letters, and “int,” indicating an integer. A complex data type is one that has some additional structure, e.g., child elements or attributes. Unlike a simple data type, a complex data type can be restricted or extended.

Type 1 in FIG. 1 is dependent on type N, as well as on the properties declared for element 2 and element 4. The full description of type 1 cannot be discovered without referring to type N. Therefore, type 1 is dependent on type N, because it relies on the properties of type N for its full description. For this reason a first dependency arrow (arrow A) is drawn from type 1 to type N. Referring to type N, additional dependencies are discovered. Type N is dependent on type 2, as demonstrated by arrow B. Therefore, type 1 is also dependent on type 2 by virtue of properties of type N depending on properties of type 2. Incidentally, type 1 is also dependent on other properties declared in type N, such as element 4. Schema properties that declare simple types defined at the World Wide Web Consortium website set forth above can be said to be “dependent” upon those simple type definitions, just as type 1 depends on type N. However, those basic definitions are not considered to be a “dependency” for the purpose of this specification. Finally, the sequence of dependencies from any given schema property down to the basic simple types can be conceptualized as a chain of dependency which may split and jump between schemas.

As one might imagine, the chain of dependencies in a large schema could become quite complex. Keep in mind that the properties used as an example here are not the only properties that may be declared in a schema. Other properties of schemas may also depend on properties declared elsewhere in a schema. Adding to the potential complexity is the possibility of one schema depending on another schema, is illustrated with respect to pseudo schema 2.

Pseudo schema 2 is dependent upon pseudo schema 1. This dependency is accomplished by an include statement, as shown. Here, the include statement means that the declarations made in schema 1 will be used for the additional declarations of schema 2. Schema 2 goes on to declare two additional data types, type 4 and type 5. Type 4 comprises an element of a complex type that is declared in schema 1. Therefore, type 4 is dependent on type 3 from schema 1. To fully discover the properties of type 4, schema 1 must be referred to. Once again, this is not the end of the process because type 3 also contains complex types. Again, a chain of dependencies can be conceptualized from each of the properties in pseudo schema 2 down to the predefined simple types.

Relying on another schema is not always desirable, however, because dependencies come with schema overhead. There may be many additional data types declared in a schema that is relied on that are not useful for a developer in a particular setting. Such schema overhead adds noise and complexity to schema creation. For example, data types with the same name present a difficulty. If there were two data types declared as type N in FIG. 1, which one would be appropriate to define element 1? A schema developer may hesitate to include a very large schema with many data types, because the numerous dependencies would add too much overhead to the task of schema creation. A developer may instead opt to create an entirely new schema to define and structure his data. By choosing this course, the developer must “reinvent the wheel” by generating the entire schema, including the simplest data types up to the most complex data types.

Those developers that do not “reinvent the wheel” in this way may find themselves in a situation somewhat like that of FIG. 2. FIG. 2 presents schema 3, a large and sophisticated schema that was developed, for example, by an organization to structure the XML for all of the organizations' documents. Naturally, divergence from schema 3 would be discouraged. Software may be written to recognize data that is structured according to schema 3. The organization may desire that all XML data is available via applications that are designed to deal with schema 3. It may want its XML to have a clean, uniform look. Eventually, however, new data types are required. A business enters a new market. A development team begins work on a new product. An author finds a more useful format for the information in a book. A scientist starts work on a new subatomic particle.

In response to the requirement for new data types, developers may create schema 4, schema 5, and schema 6. These are schemas that rely on schema 3. These developers have made the decision to endure the additional schema overhead of schema 3 in return for the wide range of function that schema 3 provides. They must remain aware of the intricacies declared in schema 3, which could become tedious.

Another development option presently available is presented in FIG. 3. Instead of relying on a monolithic schema like schema 3, a developer may include various other, less specialized schemas, into a new schema as convenient. The result of such a process is displayed in FIG. 3. The developer of schema 7 has relied on schema 8, whose developer has relied on schema 9, who in turn has relied on schema 10 and perhaps also updated schema 9 to rely on schema 7 as well. This haphazard network of dependency does not result in ideal development efficiency, but manages to leverage some useful properties out of already developed schemas. Different developers may use different schema dependencies, as they see fit for a particular project, or develop their own data types. This practice results in often “reinventing the wheel,” which in turn produces schemas with different in properties in the place of properties that could be homogenous. The look and feel of XML data within an organization may become completely non-uniform, to fit the requirements of the non-uniform schemas. Applications to deal with such non-uniform XML will require more frequent and more drastic alteration, generating still more needless labor.

In light of the aforementioned and heretofore unrecognized difficulties in the industry, there is an unaddressed need for a high-performance schema design.

### SUMMARY OF THE INVENTION

The layered schema design facilitates subsequent schema creation and can aid in homogenizing the properties of schemas that rely on it. The layered schema design provides a plurality of schemas that work together, but can be broken apart to allow for flexible access to desired properties without excess schema overhead. To accomplish this, a layered design is used, with schemas at the bottom layer providing the most basic and widespread schema properties, progressing to schemas at the top layer providing the most specialized and complex properties. Each intermediate later provides a set of properties that can rely on the properties in the layers below it, but not on the layers above it. Each layer may also include a plurality of schemas with subsets of schema properties. This allows developers of new schemas to incorporate only so much of the layered schema design as necessary. By providing a clear pattern of dependencies, developers of subsequent schemas are encouraged to make use of the layered schema, which homogenizes the properties of subsequently created XML schemas.

### BRIEF DESCRIPTION OF THE DRAWINGS

FIG. 1 illustrates a pseudo-schema, schema 1, declaring a number of properties, some of which are dependent on other declared properties. It also shows a schema 2 with properties that are dependent on properties declared in schema 1.

FIG. 2 displays a number of smaller schemas that have dependencies on a large schema. The large schema may have many properties that are unnecessary to the smaller schemas.

FIG. 3 illustrates a number of schemas that have dependencies on one another. This approach does not encourage schema uniformity and may lead to re-creating many schema properties that have already been created elsewhere.

FIG. 4 illustrates a layered schema design, with dependencies directed downward from upper to lower layers, while schemas within a layer have lateral dependencies.

FIG. 5 illustrates a five-layer schema design with dependencies directed to lower layers and complexity of implementation increasing with each outer layer.

FIG. 6 represents various embodiments of the invention as embodied in the appendix.

FIG. 7 is a graphical display of the various content models within two schemas, and how those content models can be visualized to break them down into appropriate layers for a layered schema design.

FIG. 8 shows one possible set of layers for a layered design corresponding to FIG. 7.

FIG. 9 illustrates a suggested design for layers that can be modularized into several schema files. The schema files can be separated, and then rolled into a single schema for easy reference.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Overview of the Invention

This section provides an overview of components and aspects of the invention that are explained in greater detail below.

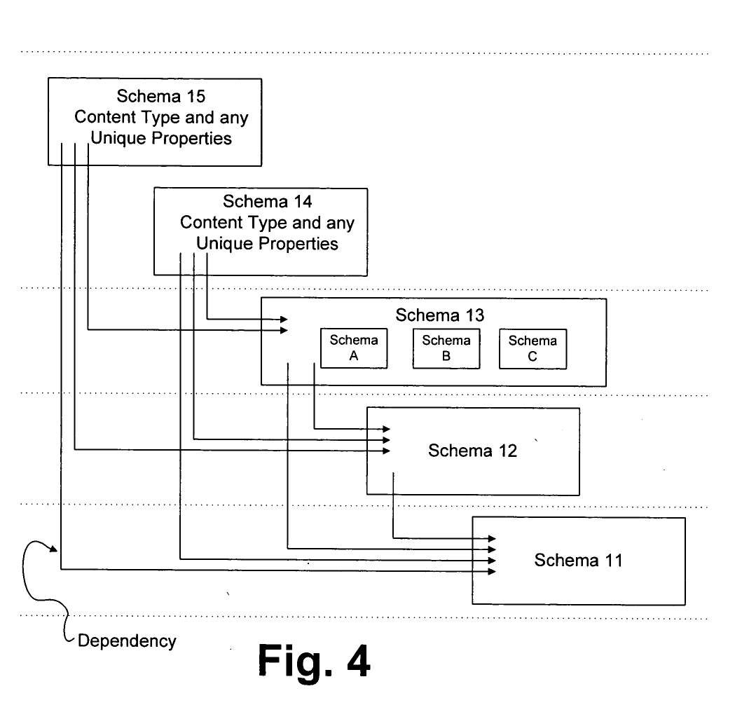

The layered schema design is illustrated in FIG. 4. FIG. 4 provides a plurality of schemas: schema 11, schema 12, schema 13, schema 14, and schema 15. The schemas are in layers represented by the horizontal dotted lines across the figure. Schema 11 is at the bottom layer, and schemas 14 and 15 are at the top layer. The arrows represent schema dependencies. All of the dependencies between layers go downward to schemas in lower layers. Schemas 14 and 15 rely on schemas 13, 12 and 11, while schema 13 relies on schemas 12 and 11, and schema 12 relies only on schema 11. This approach provides clearly defined relationships between the layers. Moreover, the relationships are easily understood by schema developers. This configuration achieves flexibility in how much of the high performance schema to use in a subsequently developed schema. A developer can build a schema that is dependent only on the bottom layer, schema 11, or on the bottom two layers, schema 11 and schema 12, or on the bottom three layers, etc.

Because the dependencies between layers in a layered schema design such as FIG. 4 go downwards, the lower layers may have many schemas relying on them, while the higher layers will have fewer schemas relying on them. As a result, the bottom layers can be more exclusive, excluding properties that are not widely shared by many schemas, while the higher layers can be more inclusive, including properties that may not be shared by other schemas. Designing the layers in this manner helps to minimize the schema overhead discussed in the background section. Schemas relying on only the lower layers need not be concerned with the additional properties declared in the higher layers.

Each layer is said to cleanly validate. Validation in the context of XML schemas encompasses two concepts. First, schemas validate as schemas, meaning they validate against the schema for schemas, and second, they can validate document instances that conform to them. In general, the first validation is necessary before the second, and the second is easily accessible as soon as you have the first. “Clean validation” refers to the first validation concept. Each layer of the layered schema design cleanly validates because it does not need information, besides the information in the layers below it, to validate XML data. This property of the layered schema design allows such a schema design to be easily subsetted. Subsetting involves defining a more restrictive subset of a schema. By enforcing the downward direction of dependencies, subsetting becomes easier. Derivation is also facilitated. XML Schema allows developers to derive new complex types from an existing simple or complex type. The structure of the layered schema design facilitates derivation because the dependencies are clear and quickly recognizable.

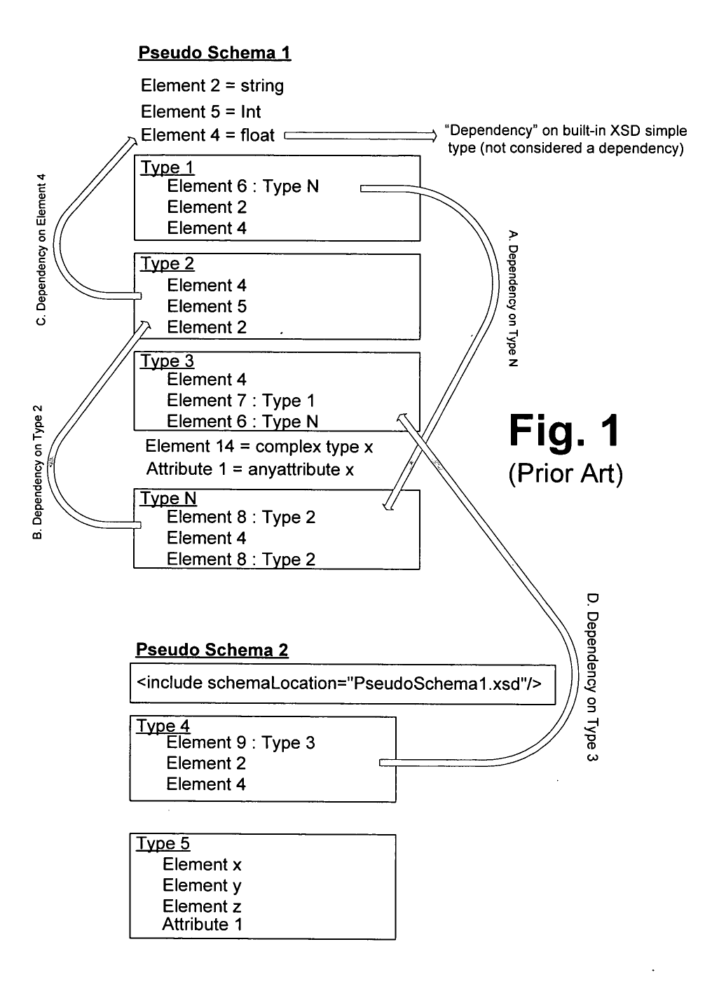

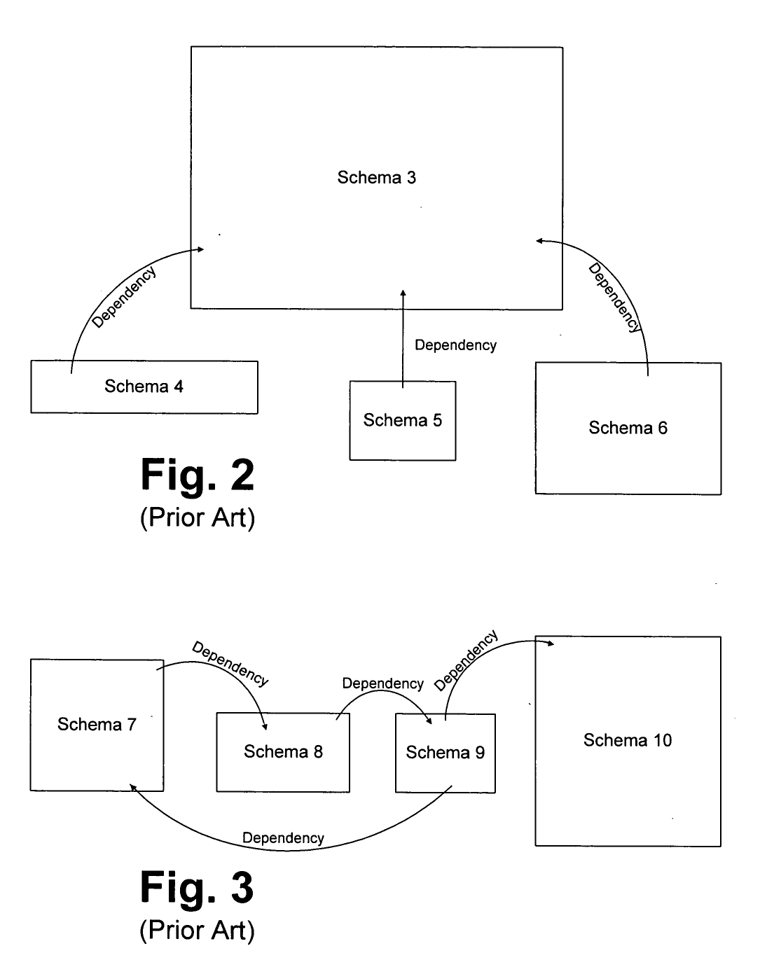

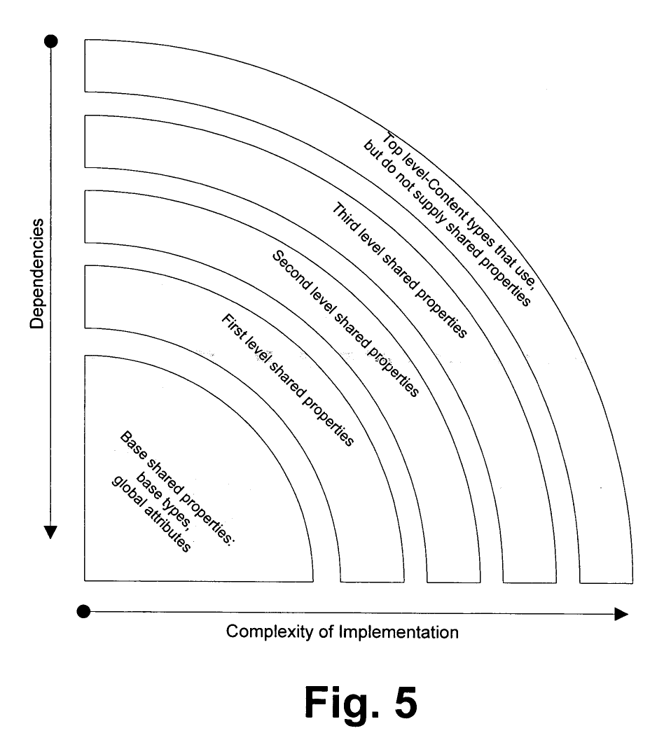

Further to this concept of schema layer design, refer to FIG. 5. FIG. 5 generally maps to FIG. 4 in that it provides multiple layers of schemas. The dependencies go down to the lower layers, while the complexity of implementation goes up with each higher layer. These two aspects of the invention are related, as can be appreciated by referring back to FIG. 1. More dependencies will inevitably lead to more complexity. The higher layers will have more dependencies because there are more layers beneath them, and therefore they will be more complex. FIG. 5 also shows that the properties declared at the lowest layer of the layered schema design may be referred to as base types and global attributes, while the schemas at the highest level—those that use but do not supply shared attributes declared at the lower levels—may be referred to as content types.

FIG. 4 shows an exemplary intermediate layer, schema 13, that comprises several discrete schemas. These are identified as schema A, schema B, and schema C. As suggested by the horizontal dependency arrows, schemas within a layer can have lateral dependency. In this regard, the multiple layers of the high performance schema design may be implemented across a set of XML schema document (“XSD”) files (an XSD file is referred to interchangeably as a schema). Individual XSD files within each layer, however, may not cleanly validate, as they may rely on other schema properties in the same layer but in other files. Alternatively, entire layers can be implemented in a single file, such as schema 12, in which case the layer would validate. Advantages of using multiple schema files versus a single schema file in a layer are discussed below.

Also in FIG. 4 is a suggestion of a “content type” name component at the top layer of the layered schema design. The top layer may include schemas that rely on any combination of lower layers. While these top-layer schemas may vary widely, it is useful to include a uniform name component for them. This name component, e.g., “content type,” signifies that a schema is a top-layer schema that relies on the layered schema design, and therefore contains some or all of the standard shared properties of the design. Such top-layer schemas can also be referred to generally by their uniform name components, e.g., as content types.

A content type, as the term is used here, is a schema that is not designed as a “building block” for other schemas. Instead, it is a schema that actually provides functional structure for an XML file. At a point where it is no longer useful to separate out the shared properties of schemas into layers, a content type may be declared. The content type may use the properties declared from the lower layers to build a functional schema for a desired XML document structure. Properties that are unique to a top-level schema may be declared for the first time in a content type schema.

### Detailed Description of Various Embodiments

The following detailed description of various embodiments of the invention generally follows the overview of the invention, above, explaining and expanding upon the components and aspects of the invention related therein, and presenting related and more specific components and aspects of the invention in detail. To provide such full and clear details as may be required by those of skill in the art to practice the invention, an appendix is attached at the end of this document that provide a single embodiment of the invention. Aspects of the embodiment provided in the appendix may be referred to from time to time to explain potential features of the invention, but these features should not be considered to be required to practice the invention, nor should they be considered an exhaustive list of all possible features of the invention.

The concept of a layered schema design warrants some additional discussion. Embodiments of the invention may be implemented with anywhere from two to theoretically any number of layers. That said, there are some practical limits on the number of layers that are desirable. Providing only two layers, a base shared properties layer such as that of FIG. 5, and a top level content type layer, without any of the intermediate layers, risks over- or under-inclusion of properties in the base shared properties layer. Too many shared properties in such a layer would be inflexible for use with many different top level schemas, while too few shared properties in such a base layer would not add sufficient useful advantage to schema developers.

Too many layers, on the other hand, would yield diminishing returns on the layers. The shared properties on the outer layers in such a system may be so infrequently used that the outer layers are rarely taken advantage of. Ultimately, a number of layers must be determined according to particular development needs. The embodiment of the invention set forth in the appendix comprises six layers.

Related to the determination of a quantity of layers is the determination of which properties are appropriate for the various layers. Some schema properties will participate in the declared data types of multiple layers, requiring them to be declared at the most exclusive layer and then referenced from the more inclusive layers. The process of determining which properties should be declared in a given layer involves conceptual separation of an element set for a top-layer schema into distinct layers. This process can be facilitated by looking at a schema as a series of content models, or subgroups of related properties, and then considering the dependencies of those content models.

Because the invention is characterized by dependencies that go from top layers towards bottom layers, a determination of which properties rely on other properties can be a part of determining appropriate properties for each layer. Schema dependencies, to define them, are the reliance of one or more schema properties on another schema property for complete information about the first schema properties. Schema properties are generally considered to be content types, elements, and attributes. For example, a hypothetical foo element might have hypothetical bar and baz elements in its content model. As a result, foo is dependent on bar and baz. The reverse is not true; neither bar or baz have an explicit relationship with foo.

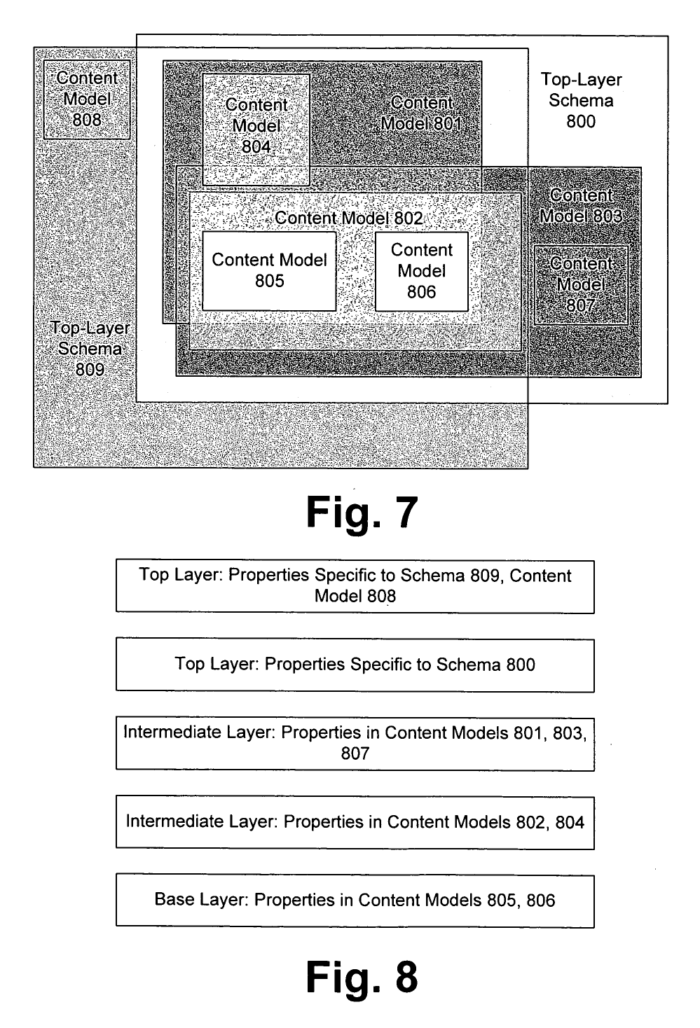

A simplified illustration of the process of placing properties in layers is set forth in FIG. 7. FIG. 7 is considered simplified because it presents only two top-layer schemas, 800 and 809. More top-layer schemas, with more content models, might better reflect the realities of schema design. FIG. 7 nonetheless accurately reflects the concept of breaking schemas into content models to determine which properties should be in the various layers of a layered schema design. With reference to that figure, a top-layer schema 800 is shown that comprises properties that can be grouped into any number of content models. The content models are subsets of related schema properties as determined by a schema developer.

In FIG. 7, content models encompassed entirely inside another content model contain only properties that are relied on by the encompassing content model. For example, content model 805 and content model 806 contain only properties that are relied on by content model 802. Content model 802 contains only properties that are relied on by content model 803, and mostly, but not entirely, properties that are relied on by content model 801. The task of creating a layered schema design can be characterized, in part, as determining a set of content models as in FIG. 7, and then determining appropriate layer divisions. The task involves looking past the likely properties of a single schema 800, and instead looking at the likely properties of multiple schemas 800 and 809. Content models may be defined as necessary by a developer to determine an appropriate layer for schema properties.

An exemplary layer division for FIG. 7 is provided in FIG. 8. FIG. 8 represents layer division choices that may be made by a developer. As displayed, the properties in content models 805 and 806 could be in a bottom, or base layer, because those properties are relied on by most other content models of both schema 800 and schema 809. The properties of content models 802 and 804 might go into the next layer, again because these properties are relied on by most of the remaining content models. If a content model such as 804 contains very few properties that are relied on by many other content models such as 803, it may be appropriate to redefine the content models and separate the properties so that the overhead properties of content model 804 are not carried in the second layer. A third layer might include content models 801, 803, and 807. After such a third layer it may be best in the illustrated situation to discontinue construction of additional layers. There may be no more shared properties to place in layers, or those remaining shared properties may be too few to warrant incorporation into a layer. If this is the case, construction of layers may be discontinued, and the creation of an embodiment of a layered schema design considered complete. Remaining properties specific to top-layer schemas, such as those of schema 800 or those of schema 809 with content model 808 can be tailored to such schemas as necessary.

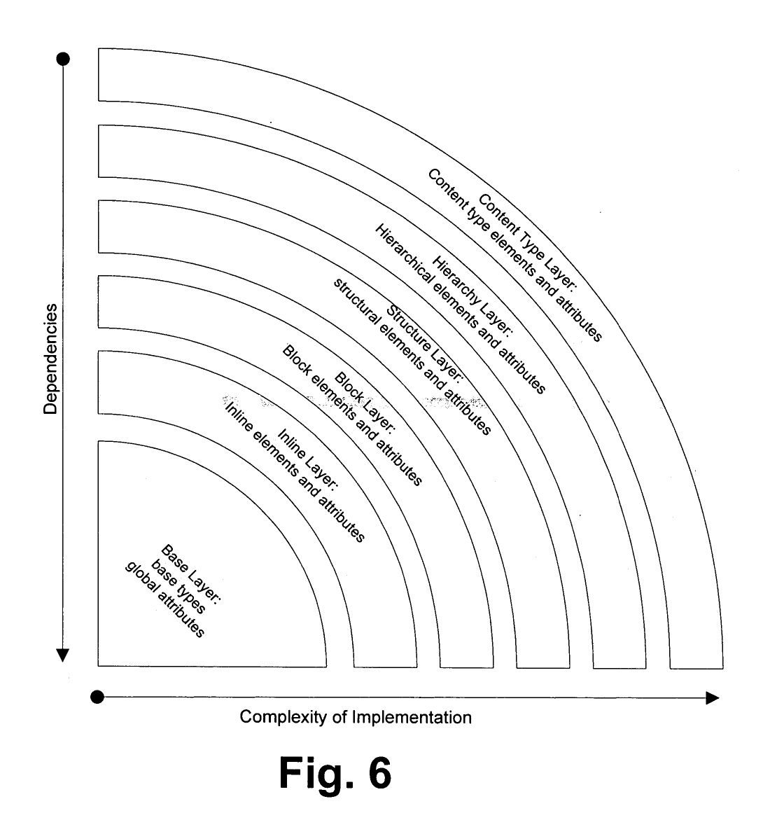

The choices inherent in developing a layered schema design cannot be laid out in full here for every setting in which the invention may be implemented. While these choices are important to the quality of the layered schema created, they must be made in relation to the particular data structure, and ultimately in relation to a subset of XML data for which a layered schema design is required. While the invention is not limited to a particular set of choices, a technique for determining an appropriate schema design is set forth herein. In this regard, an embodiment for one set of choices for layer divisions is included in the appendix to this document. The layer divisions set forth in the appendix show an implementation of the invention in the setting of text documents. FIG. 6 corresponds generally to the layers created in the appended embodiment. There are six layers presented graphically in FIG. 6, and the following brief discussion will address the layers of FIG. 6 as a means of demonstrating the general techniques for layered schema design.

First, with reference to the appendix and FIG. 6, note that the layers in this embodiment are named as follows, from lowest to highest: Base (most exclusive), Inline, Block, Structure, Hierarchy, Content Type (most inclusive). These names reflect the properties that are in the various layers of this particular embodiment. Naming the layers in a way that the likely contents are easily recognized by a human reader is suggested, after all it will be human developers that use the high performance schema to create their own individualized schemas. For example, the base layer contains the most basic or generic properties in the layered schema design, which will be accessed as necessary from the other layers and the top-layer schemas.

The contents of each layer in FIG. 6 can be determined according to both practical and aesthetic reasons. Exemplary properties included for practical reasons are, first, the base layer contains a highly practical declaration of allowable media file formats. The Inline and Block layers contain declarations for inline and block textual elements, respectively. The Structure layer contains elements that might contain blocks, but might also contain other elements that reside at the Structure layer. The Hierarchy layer contains a set of sectioning elements and a set of types that are used at the Content Type layer. The Content Type layer describes elements that are most often root elements whose content models are made up entirely of elements from lower layers; however, elements that are unique to their content types might also be declared at the Content Type layer.

As illustrated in FIG. 4, schema 13, and in the appended embodiment, each layer can comprise any number of XSD files. Ideally, the file names suggest the layer or content type and the properties being defined. For example, “inlineLinking.xsd,” is a XSD file name which suggests that the file is a part of an inline layer. Properties or files within a particular layer that are specific to a particular top-layer or content type can be named to so indicate. For example a file called “taskExecution.xsd”, may be so named because it is specific to a task content type, so is prefixed via the content type name, rather than the layer name. This model allows a human schema reader or implementer to quickly determine which files to look at to find any properties in which they are interested.

Suggested properties for such a base layer in the context of text documents, as can be seen in the appendix, are a basic text property for identifying text throughout the other schemas, and a property for identifying data that will be replaced and the corresponding data that it will be replaced with, as illustrated by the “replace with” attribute in the exemplary base layer of the appendix. Other suggested properties, also in the exemplary base layer, are a conditional delete property, which can be an attribute for marking data to be deleted when some other referenced data is deleted, and a property for marking data so that it can be referenced from many locations in an XML document—making updating the data in all locations a one-step operation.

Additional properties that are suggested for the various layers of a layered schema design may be found in the appendix. To point out a few, elements for identifying common text document properties are useful in the bottom layers of a layered schema design. Such elements are an acronym element for identifying acronyms, an abbreviation element for identifying abbreviations, a quotation element for identifying quotations, a date element for identifying dates, a foreign phrase element for identifying foreign phrases, a conditional element for marking data to be conditionally included, a subscript element for identifying subscripts, and a superscript element for identifying superscripts. Also, when the layered design is used for text documents, common structural properties are useful such as paragraph element for identifying paragraphs and a title element for identifying titles, a table element for identifying tables, an entry element for identifying table entries, a list element for identifying lists, a procedure element for identifying a procedure, and a step element for identifying a step in a procedure. It may be preferable to provide a property for separating sections of a text document in one of the higher layers. The top schemas, also referred to here as content types, that refer to the layers, once again in the context of text documents can be a glossary, a frequently asked questions document, and a reference document. Of course, these suggestions are capable of wide expansion to the various documents that can be defined with a layered schema design.

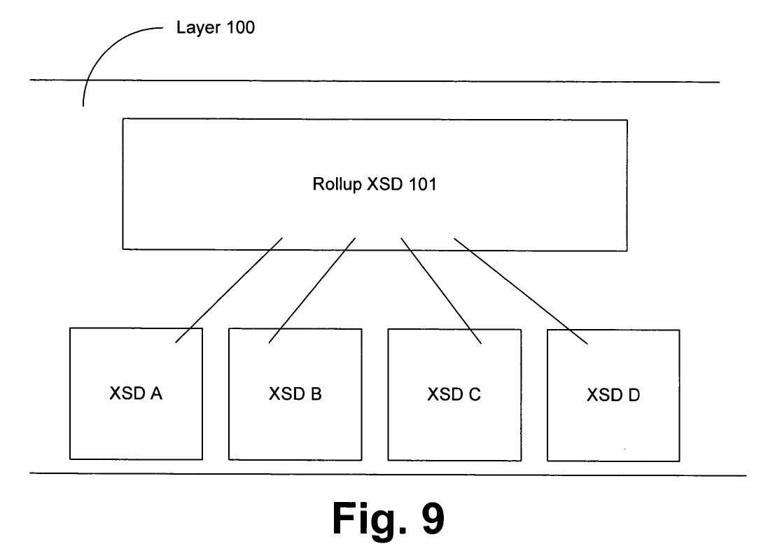

Further with reference to including multiple schemas in a particular layer, these schemas can be included in a “rollup” schema to make them easily accessible as a group from any schema that relies on the layer. This is illustrated in FIG. 9. There are also examples of rollup schemas in the appendix. Block.xsd is one such example. Referring to FIG. 9, a rollup schema provides an easy way to rely on all of the schemas in a particular layer. A call to the rollup XSD 101 will also call in the subsidiary XSD files, XSD A, XSD B, XSD C, and XSD D. These subsidiary schemas may also be called individually of the rollup XSD 101. However, providing a rollup XSD 101 allows those using the high performance schema design to quickly and cleanly access the entire functionality of a layer. Multiple rollups may be included in a given layer if desired.

The invention is not limited to the exact layer structure shown in the figures. Another embodiment of the invention could comprise “layer trees,” in which a single base layer supports various intermediate layers that branch in different directions. For example, two second layers could each support a different third, fourth, and fifth layer, leading to a design that could be depicted graphically as a base layer with two layer columns resting on top of it. Also, while the dependencies are designed generally to go downwards in a layer, implementations that employ otherwise directed dependencies while using the other aspects of layered schema design would be considered to practice the invention.

Finally, it should be understood that the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the user interface techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing the present invention in the context of one or more stand-alone computer systems, the invention is not so limited, but rather may be implemented in connection with any computing environment, such as a network or distributed computing environment. Still further, the present invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes. Therefore, the present invention should not be limited to any single embodiment, but rather should be construed in breadth and scope in accordance with the appended claims.

### APPENDIX

Exemplary Layered Schema

A. First Layer

base.xsd

```
<?xml version=“1.0” encoding=“utf-8”?>
<schema targetNamespace=“http://schemas.organization.com/layrschma/2003/5”
  xmlns:doc=“http://schemas.organization.com/layrschma/internal”
  xmlns:layrschma=“http://schemas.organization.com/layrschma/2003/5”
  xmlns=“http://www.w3.org/2001/XMLSchema”
  elementFormDefault=“qualified”
  attributeFormDefault=“unqualified”>
  <!-- simpleType declarations -->
  <simpleType name=“alertTypesType”>
    <annotation>
      <documentation>
The alertTypesType simpleType provides a list of the various types of alerts that can be used to
describe alerts.
      </documentation>
    </annotation>
    <restriction base=“string”>
      <enumeration value=“tip”/>
      <enumeration value=“note”/>
      <enumeration value=“caution”/>
      <enumeration value=“important”/>
      <enumeration value=“warning”/>
      <enumeration value=“bestpractice”/>
      <enumeration value=“other”/>
    </restriction>
  </simpleType>
  <!-- attribute declarations -->
  <simpleType name=“conditionStringType”>
    <restriction base=“anyURI”/>
  </simpleType>
  <attributeGroup name=“addressAttributeGroup”>
    <attribute name=“address” type=“ID”>
      <annotation>
        <documentation>
The address attribute describes the attached content with a unique ID/GUID/URI that can be
referenced for sharing, hyperlinking or other purposes.
        </documentation>
      </annotation>
    </attribute>
  </attributeGroup>
  <attributeGroup name=“contentIdentificationSharingAndConditionGroup”>
    <annotation>
      <documentation>
The contentIdentificationSharingAndConditionGroup provides a set of attributes for identifying
content and for marking it for sharing and conditional filtering.
      </documentation>
    </annotation>
    <attributeGroup ref=“layrschma:addressAttributeGroup”/>
    <attribute name=“condition” type=“token”>
      <annotation>
        <documentation>
The value of this attribute is a reference to a condition set that holds one or more conditions that
must be met if the element to which this attribute is applied is to be considered ‘relevant’. (Relevance
may be a build-time or a run-time concept).
    </documentation>
      </annotation>
    </attribute>
    <attribute name=“replaceWith” type=“anyURI”>
      <annotation>
        <documentation>
The replaceWith attribute specifies the content fragment, either a LAYRSCHMAPart, a
LAYRSCHMAResource or a fragment within an existing LAYRSCHMA document instance, with
which the parent element should be replaced at some later time (build time, rendering time).
        </documentation>
        <documentation>
There is not a particular element that enables authors to point to content fragments with the
expectation a content fragment would be embedded in place of the reference at build time. The
approach used in this schema is that a copy of the desired embeddable content fragment should be
embedded in the document and that a fresh copy of the content fragment should be retrieved prior to
presenting the instance to end users. This approach has two main benefits: authors can see all the
content inline and there is no negative impact to schema content models.
        </documentation>
      </annotation>
    </attribute>
    <attribute name=“conditionalDelete” type=“anyURI”>
      <annotation>
        <documentation>
When the item being replaced consists of multiple root elements, the first element uses the
replaceWith attribute and subsequent elements use the conditionalDelete attribute.
        </documentation>
      </annotation>
    </attribute>
  </attributeGroup>
  <attributeGroup name=“linkingGroup”>
    <attribute name=“href” type=“anyURI”/>
    <attribute name=“uri” type=“anyURI”/>
    <attribute name=“summary” type=“string”/>
    <attributeGroup ref=“layrschma:contentIdentificationSharingAndConditionGroup”/>
  </attributeGroup>
  <!-- complexType declarations -->
  <complexType name=“textType”>
    <annotation>
      <documentation>
This type includes the common attributes and allows character data.
      </documentation>
    </annotation>
    <simpleContent>
      <extension base=“normalizedString”>
        <attributeGroup
ref=“layrschma:contentIdentificationSharingAndConditionGroup”/>
      </extension>
    </simpleContent>
  </complexType>
</schema>
```

B. Second Layer [Note: this Layer Presents an Exemplary Rollup]

inline.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“inlineCommon.xsd”/>
  <include schemaLocation=“inlineSoftware.xsd”/>
  <include schemaLocation=“base.xsd”/>
  <group name=“inlineBasicGroup”>
  <choice>
      <group ref=“layrschma:inlineCommonGroup”/>
  </choice>
  </group>
  <group name=“inlineGroup”>
  <choice>
      <group ref=“layrschma:inlineBasicGroup”/>
      <group ref=“layrschma:inlineSoftwareGroup”/>
  </choice>
  </group>
  <!-- complexType declarations -->
  <complexType name=“inlineType” mixed=“true”>
    <annotation>
      <documentation>
The inlineType complexType describes a simple inline-only content model. It provides both text
and elements with similarly simple content models.
      </documentation>
    </annotation>
    <choice minOccurs=“0” maxOccurs=“unbounded”>
      <group ref=“layrschma:inlineGroup”/>
    </choice>
    <attributeGroup ref=“layrschma:contentIdentificationSharingAndConditionGroup”/>
  </complexType>
</schema>
```

inlinecommon.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“base.xsd”/>
  <!-- element declarations -->
  <element name=“quoteInline” type=“layrschma:textType”>
    <annotation>
      <documentation>
The quoteInline element describes an inline quotation.
      </documentation>
    </annotation>
  </element>
  <element name=“date” type=“date”>
    <annotation>
      <documentation>
The date element describes a date.
      </documentation>
    </annotation>
  </element>
  <element name=“conditionalInline” type=“layrschma:inlineType”>
    <annotation>
      <documentation>
The conditionalInline element is a wrapper element for a run of text. This element will be used for
inline conditions. In particular, it will be used to specify that a run of text is conditional, using the
smart links state monitor.
      </documentation>
    </annotation>
  </element>
  <element name=“notLocalizable” type=“layrschma:inlineType”>
    <annotation>
      <documentation>
The notLocalizable element is a wrapper element for a run of text. It specifies that that run of text
should not be localized. This would be the case with a proper name, for example.
      </documentation>
    </annotation>
  </element>
  <!-- group declarations -->
  <group name=“inlineCommonGroup”>
    <annotation>
      <documentation>
This type describes the set of inline elements that are likely to be needed for block elements' content
models.
      </documentation>
    </annotation>
    <choice>
      <element ref=“layrschma:quoteInline”/>
      <element ref=“layrschma:date”/>
      <element ref=“layrschma:conditionalInline”/>
      <element ref=“layrschma:notLocalizable”/>
    </choice>
  </group>
</schema>
```

inlinesoftware.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“base.xsd”/>
  <!-- element declarations -->
  <element name=“internetUri”>
    <annotation>
      <documentation>
The internetUri element describes an internet address, such as a web or email address.
      </documentation>
    </annotation>
    <complexType>
      <simpleContent>
        <extension base=“layrschma:textType”>
          <attribute name=“type”>
            <simpleType>
              <restriction base=“token”>
                <enumeration value=“email”/>
                <enumeration value=“web”/>
                <enumeration value=“ftp”/>
              </restriction>
            </simpleType>
          </attribute>
        </extension>
      </simpleContent>
    </complexType>
  </element>
  <element name=“environmentVariable” type=“layrschma:textType”>
    <annotation>
      <documentation>
The environmentVariable element describes an environment variable in an operating system.
      </documentation>
    </annotation>
  </element>
  <!-- group declarations -->
  <group name=“inlineSoftwareGroup”>
    <choice>
      <element ref=“layrschma:internetUri”/>
      <element ref=“layrschma:environmentVariable”/>
    </choice>
  </group>
</schema>
```

C. Third Layer [Example Rollup]

block.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“blockCommon.xsd”/>
  <include schemaLocation=“blockSoftware.xsd”/>
  <!-- complexType declarations -->
  <complexType name=“blockType”>
    <annotation>
      <documentation>
The block complexType describes a simple block-only content model. It is intended as the content
model for structural elements.
      </documentation>
    </annotation>
    <group ref=“layrschma:blockGroup” minOccurs=“0” maxOccurs=“unbounded”/>
    <attributeGroup ref=“layrschma:contentIdentificationSharingAndConditionGroup”/>
  </complexType>
  <group name=“blockGroup”>
    <choice>
      <group ref=“layrschma:blockCommonGroup”/>
      <group ref=“layrschma:blockSoftwareGroup”/>
    </choice>
  </group>
</schema>
```

blockcommon.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“inline.xsd”/>
  <!-- Element declarations -->
  <element name=“para” type=“layrschma:inlineType”>
    <annotation>
      <documentation>
The para element describes a paragraph. It is the most basic documentation unit.
      </documentation>
    </annotation>
  </element>
  <element name=“title” type=“layrschma:textType”>
    <annotation>
      <documentation>
The title element describes the name of a part of the document.
      </documentation>
    </annotation>
  </element>
  <element name=“alert”>
    <annotation>
      <documentation>
The alert element describes an slim alert structure that largely mimics the block alert structure.
      </documentation>
    </annotation>
    <complexType mixed=“true”>
      <complexContent>
        <extension base=“layrschma:inlineType”>
          <attribute name=“class” type=“layrschma:alertTypesType”
use=“required”>
            <annotation>
              <documentation>
The class attribute describes the type of alert.
              </documentation>
            </annotation>
          </attribute>
        </extension>
      </complexContent>
    </complexType>
  </element>
  <!-- group declarations -->
  <group name=“blockCommonGroup”>
    <choice>
      <element ref=“layrschma:para”/>
      <element ref=“layrschma:alert”/>
    </choice>
  </group>
</schema>
```

blocksoftware.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“inline.xsd”/>
  <!-- Element declarations -->
  <element name=“code”>
    <annotation>
      <documentation>
The code element describes a code fragment.
      </documentation>
    </annotation>
    <complexType mixed=“true”>
      <choice>
        <element name=“comment” type=“string” minOccurs=“0”
maxOccurs=“unbounded”>
          <annotation>
            <documentation>
The comment element allows for the description of code/developer comments within a code block.
            </documentation>
          </annotation>
        </element>
      </choice>
      <attributeGroup
ref=“layrschma:contentIdentificationSharingAndConditionGroup”/>
    </complexType>
  </element>
  <!-- group declarations -->
  <group name=“blockSoftwareGroup”>
    <choice>
      <element ref=“layrschma:code”/>
    </choice>
  </group>
</schema>
```

D. Fourth Layer [Example Rollup]

structure.xsd

```
<?xml version=“1.0” encoding=“utf-8” ?>
<schema xmlns=“http://www.w3.org/2001/XMLSchema”
    xmlns:layrschma=“http://schemas.organization.com/layrschma/2003/5”
    xmlns:doc=“http://schemas.organization.com/layrschma/internal”
    targetNamespace=“http://schemas.organization.com/layrschma/2003/5”
    elementFormDefault=“qualified”
    attributeFormDefault=“unqualified”>
  <!-- include and import declarations -->
  <include schemaLocation=“base.xsd”/>
  <include schemaLocation=“block.xsd”/>
  <include schemaLocation=“structureList.xsd”/>
  <!-- complexType declarations -->
  <complexType name=“structureType”>
    <annotation>
      <documentation>
This type describes the common structure elements. It is intended for use in page types and
structure elements.
      </documentation>
    </annotation>
    <group ref=“layrschma:structureGroup” minOccurs=“0” maxOccurs=“unbounded”/>
    <attributeGroup ref=“layrschma:contentIdentificationSharingAndConditionGroup”/>
  </complexType>
  <complexType name=“structureSimpleType”>
    <annotation>
      <documentation>
The structureSimple type is intended for cases where both structure and block elements are needed;
however, a limited set of elements is desired.
      </documentation>
    </annotation>
    <group ref=“layrschma:structureSimpleGroup” minOccurs=“0”
maxOccurs=“unbounded”/>
    <attributeGroup ref=“layrschma:contentIdentificationSharingAndConditionGroup”/>
  </complexType>
  <group name=“structureGroup”>
    <choice>
      <group ref=“layrschma:blockGroup”/>
      <group ref=“layrschma:structureListGroup”/>
    </choice>
  </group>
  <group name=“structureSimpleGroup”>
    <choice>
      <element ref=“layrschma:para”/>
      <element ref=“layrschma:list”/>
    </choice>
  </group>
</schema>
```

structurelist.xsd

```
<?xml version=“1.0” encoding=“utf-8”?>
<schema targetNamespace=“http://schemas.organization.com/layrschma/
2003/5”
      xmlns=“http://www.w3.org/2001/XMLSchema”
      xmlns:layrschma=“http://schemas.organization.com/layrschma/
      2003/5”
        xmlns:doc=“http://schemas.organization.com/layrschma/internal”
          elementFormDefault=“qualified”
attributeFormDefault=“unqualified”>
  <!-- include and import declarations -->
  <include schemaLocation=“base.xsd”/>
  <!-- element declarations -->
  <element name=“list”>
    <annotation>
      <documentation>
The list element describes content that should be displayed as a list.
      </documentation>
    </annotation>
    <complexType>
      <sequence>
        <element ref=“layrschma:listItem” maxOccurs=“unbounded”/>
      </sequence>
      <attribute name=“class” use=“required”>
        <annotation>
          <documentation>
The class attribute describes the type of list.
          </documentation>
        </annotation>
        <simpleType>
          <restriction base=“string”>
            <enumeration value=“bullet”/>
            <enumeration value=“nobullet”/>
            <enumeration value=“ordered”/>
            <enumeration value=“checklist”/>
            <enumeration value=“radiobutton”/>
          </restriction>
        </simpleType>
      </attribute>
      <attributeGroup
ref=“layrschma:contentIdentificationSharingAndConditionGroup”/>
    </complexType>
  </element>
  <element name=“listItem” type=“layrschma:structureType”>
    <annotation>
      <documentation>
        The listItem element describes an item within a list. The
        content of the listItem element will be treated as a unit.
      </documentation>
    </annotation>
  </element>
  <!-- group declarations -->
  <group name=“structureListGroup”>
    <annotation>
      <documentation>
This group describes the common lists that can be used to describe
list data.
      </documentation>
    </annotation>
    <choice>
      <element ref=“layrschma:list”/>
    </choice>
  </group>
</schema>
```

E. Fifth Layer [Example Rollup]

hierarchy.xsd

```
<?xml version=“1.0” encoding=“utf-8”?>
<schema targetNamespace=“http://schemas.organization.com/layrschma/
2003/5”
      xmlns=“http://www.w3.org/2001/XMLSchema”
      xmlns:layrschma=“http://schemas.organization.com/layrschma/
      2003/5”
        xmlns:doc=“http://schemas.organization.com/layrschma/internal”
          elementFormDefault=“qualified”
attributeFormDefault=“unqualified”>
  <!-- include and import declarations -->
  <include schemaLocation=“structure.xsd”/>
  <!-- complexType declarations -->
  <complexType name=“contentTypeType”>
    <complexContent>
      <extension base=“layrschma: sectionType”>
        <sequence>
          <element ref=“layrschma: alertSet” minOccurs=“0”/>
          <element ref=“layrschma:relatedTopics” minOccurs=“0”/>
          <element ref=“layrschma:reusableContent” minOccurs=“0”/>
          <element ref=“layrschma:copyright” minOccurs=“0”/>
        </sequence>
        <attribute name=“contentType” type=“token”/>
      </extension>
    </complexContent>
  </complexType>
</schema>
```

F. Sixth Layer [Top Layer Schema: Content Type]

enduser.xsd

<?xml version=“1.0” encoding=“utf-8” ?>
<schema xmlns=“http://www.w3.org/2001/XMLSchema”

xmlns:layrschma=“http://schemas.organization.com/layrschma/2003/5”
xmlns:doc=“http://schemas.organization.com/layrschma/internal”
targetNamespace=“http://schemas.organization.com/layrschma/2003/5”
elementFormDefault=“qualified”
attributeFormDefault=“unqualified”>

<!-- Schema documentation -->
<annotation>

<documentation>

This schema describes the end user content types of LAYRSCHMA. These content types represent
schema structures that are used to create documentation for end-users. End user structures are
pervasive in Windows XP and Office XP documentation.

</documentation>

</annotation>
<!-- include and import declarations -->
<include schemaLocation=“structure.xsd”/>
<!-- element declarations -->
<element name=“conceptual” type=“layrschma:contentTypeType”>

<annotation>

<documentation>

The conceptual element describes the content model for the conceptual content type. Conceptuals
describe high-level explanations of particular technology areas.

</documentation>

</annotation>

</element>
<element name=“procedural” type=“layrschma:contentTypeType”>

<annotation>

<documentation>

The procedure element specifies the content model for the procedure content type. Procedures
describe some process or set of processes that users are intended to follow to accomplish some task,
such as installing a printer.

</documentation>

</annotation>

</element>
<complexType name=“contentTypeType”>

<sequence>

<element ref=“layrschma:title”/>
<group ref=“layrschma:structureGroup” minOccurs=“0”

maxOccurs=“unbounded”/>

</sequence>

</complexType>

</schema>

1. A plurality of schemas, comprising:
a plurality of schemas declaring a plurality of properties; and
a first group of at least one schema within said plurality of schemas in a base layer; and
a second group of at least one schema within said plurality of schemas in an intermediate layer; and
two or more top layer schemas that each provide a complete document structure; wherein
any properties declared within said second group that are dependent on schemas outside said second group are dependent on properties declared within said base layer; and
at least one property declared within each of said two or more top layer schemas is dependent on a property declared in said first group or in said second group.

2. The plurality of schemas of claim 1, wherein said first group of at least one schema declares a basic text type for identifying text.

3. The plurality of schemas of claim 1, wherein said first group of at least one schema declares an attribute for identifying data that will be replaced and corresponding data that the identified data will be replaced with.

4. The plurality of schemas of claim 3, wherein said first group of at least one schema declares an attribute for marking data proximal to the identified data that will also be replaced with the corresponding data.

5. The plurality of schemas of claim 1, wherein said first group of at least one schema declares an attribute for identifying data that can be referenced in multiple locations of an XML document, thereby supporting easy updating of the data.

6. The plurality of schemas of claim 1, wherein said first group of at least one schema or said second group of at least one schema declares one or more of an acronym element for identifying acronyms, an abbreviation element for identifying abbreviations, a quotation element for identifying quotations, a date element for identifying dates, a foreign phrase element for identifying foreign phrases, a conditional element for marking data to be conditionally included, a subscript element for identifying subscripts, and a superscript element for identifying superscripts.

7. The plurality of schemas of claim 1, wherein said first group of at least one schema or said second group of at least one schema declares one or more of a paragraph element for identifying paragraphs and a title element for identifying titles.

8. The plurality of schemas of claim 1, wherein said first group of at least one schema or said second group of at least one schema declares one or more of a table element for identifying tables, an entry element for identifying table entries, a list element for identifying lists, a procedure element for identifying a procedure, and a step element for identifying a step in a procedure.

9. The plurality of schemas of claim 1, wherein said first group of at least one schema or said second group of at least one schema declares a section element for identifying sections of a document.

10. The plurality of schemas of claim 1, wherein said first group of at least one schema or said second group of at least one schema comprises three or more schemas, and wherein at least one schema of said three or more schemas incorporates some or all of the other schemas of said three or more schemas.

11. The plurality of schemas of claim 1, wherein at least one of said two or more top layer schemas defines a complete document structure for one or more of a glossary, a frequently asked questions document, and a reference document.

12. The plurality of schemas of claim 1, wherein at least one of said first group of at least one schema and said second group of at least one schema is represented in a computer readable medium.

13. A method for generating a plurality of related schemas, comprising:
declaring a first group of properties in at least one first schema, and
declaring at least one intermediate group of properties in at least one second schema,
wherein each of said at least one intermediate group of properties do not depend on any properties other than those declared in itself, those declared in the first group of properties, and those declared in intermediate groups of properties between itself and said first group of properties; and
generating at least one schema with properties that depend on some or all of the properties in said first group of properties and said at least one intermediate group of properties.

14. The method of claim 13, further comprising inserting additional properties into one or more of the first group of properties, the at least one intermediate group of properties, and at least one schema that results from said generating, by carrying out steps comprising:
determining if said additional properties are common to more than one of the at least one schema that results from said generating at least one schema; and
inserting any additional properties that are common into one or more of said first group of properties and said at least one intermediate group of properties; and
inserting any additional properties that are not common into the at least one schema that results from said generating at least one schema.

15. The method of claim 13, wherein at least one property in the first group of properties declares a basic text type for identifying text.

16. The method of claim 13, wherein at least one property in the first group of properties declares an attribute for identifying data that will be replaced and corresponding data that the identified data will be replaced with.

17. The method of claim 16, wherein at least one property in the first group of properties declares an attribute for marking data proximal to the identified data that will also be replaced with the corresponding data.

18. The method of claim 13, wherein at least one property in the first group of properties declares an attribute for identifying data that can be referenced in multiple locations of a document instance, thereby supporting easy updating of the data.

19. The method of claim 13, wherein at least one property in the first group of properties or in the at least one intermediate group of properties declares one or more of an acronym element for identifying acronyms, an abbreviation element for identifying abbreviations, a quotation element for identifying quotations, a date element for identifying dates, a foreign phrase element for identifying foreign phrases, a conditional element for marking data to be conditionally included, a subscript element for identifying subscripts, and a superscript element for identifying superscripts.

20. The method of claim 13, wherein at least one property in the first group of properties or in the at least one intermediate group of properties declares one or more of a paragraph element for identifying paragraphs and a title element for identifying titles.

21. The method of claim 13, wherein one or more of the at least one first schema and the at least one second schema comprises a plurality of schemas, and wherein at least one schema in said plurality of schemas refers some or all of the other schemas in said plurality of schemas.

22. The layered design of claim 13, wherein at least one schema that results from said generating defines a complete document structure for one or more of a glossary, a frequently asked questions document, and a reference document.

23. A computer readable medium with a recorded representation of a plurality of schemas, comprising:
a plurality of schemas declaring a plurality of properties; and
a first group of at least one schema within said plurality of schemas in a base layer; and
a second group of at least one schema within said plurality of schemas in an intermediate layer; and
two or more top layer schemas that each provide a complete document structure; wherein
any properties declared within said second group that are dependent on schemas outside said second group are dependent on properties declared within said base layer; and
at least one property declared within each of said two or more top layer schemas is dependent on a property declared in said first group or in said second group.

24. The computer readable medium of claim 23, wherein said first group of at least one schema declares a basic text type for identifying text.

25. The computer readable medium of claim 23, wherein said first group of at least one schema declares an attribute for identifying data that will be replaced and corresponding data that the identified data will be replaced with.

26. The computer readable medium of claim 23, wherein said first group of at least one schema declares an attribute for marking data proximal to the identified data that will also be replaced with the corresponding data.

27. The computer readable medium of claim 23, wherein said first group of at least one schema declares an attribute for identifying data that can be referenced in multiple locations of an XML document, thereby supporting easy updating of the data.

28. The computer readable medium of claim 23, wherein said first group of at least one schema or said second group of at least one schema declares one or more of a paragraph element for identifying paragraphs and a title element for identifying titles.

29. The computer readable medium of claim 23, wherein said first group of at least one schema or said second group of at least one schema declares a section element for identifying sections of a document.

30. The computer readable medium of claim 23, wherein at least one of said two or more top layer schemas defines a complete document structure for one or more of a glossary, a frequently asked questions document, and a reference document.
